(19) United States
(12) Patent Application Publication
(10) Pub. No.: US 2025/0034494 A1
(43) Pub. Date: Jan. 30, 2025

(54) method and system for accelerated aging of alcoholic spirits using controlled pressure differences.

(71) Applicant: Charles Bernard Herrick, Prosper, TX (US)

(72) Inventor: Charles Bernard Herrick, Prosper, TX (US)

(21) Appl. No.: 18/225,703

(22) Filed: Jul. 25, 2023

(51) Int. Cl. C12H 1/22; C12G 3/07

(52) U.S. Cl. CPC C12H 1/22; C12G 3/07

(57) ABSTRACT

The invention provides a method and system for accelerated aging of alcoholic spirits using controlled pressure differences inside and outside a sealed barrel. The method comprises: filling a sealed barrel with an alcoholic spirit; sealing the barrel with a valve; connecting the valve to a pressure controller; setting a desired pressure difference between the inside and outside of the barrel; applying the pressure difference for a predetermined time; reversing the pressure difference for another predetermined time; and repeating the cycle until a desired flavor profile is achieved. The invention can accelerate the aging process by enhancing the extraction of compounds from the wood, increasing the evaporation of water and alcohol, and promoting the chemical reactions between the spirit and the wood. The invention can also improve the consistency and quality of the aged spirits by reducing the variability of environmental factors.

### CROSS-REFERENCE TO RELATED APPLICATIONS

No related applications have been previously filed.

### TITLE OF THE INVENTION

A method and system for accelerated aging of alcoholic spirits using controlled pressure differences

### TECHNICAL FIELD OF THE INVENTION

The invention relates to the field of alcoholic beverage production, and more specifically, to a method and system for enhancing the flavor and quality of alcoholic spirits by applying controlled pressure differences inside and outside the barrels.

### BACKGROUND OF THE INVENTION

The aging of alcoholic spirits in wooden barrels is a traditional and widely used technique to improve the flavor, aroma, color and smoothness of the final product. However, this process is slow, expensive and unpredictable, as it depends on various environmental factors such as temperature, humidity and atmospheric pressure. These factors affect the rate of extraction of compounds from the wood, the evaporation of water and alcohol, and the chemical reactions between the spirit and the wood. The atmospheric pressure in particular influences the expansion and contraction of the barrel and the spirit, creating a pumping effect that forces the spirit in and out of the wood pores. However, the atmospheric pressure is not constant and varies according to the weather conditions, which makes it difficult to control and optimize the aging process.

Various methods have been proposed to accelerate the aging process of alcoholic spirits by using physical or chemical means, such as irradiation, ultrasound, electric fields, enzymes, acids, gases, or additives. However, these methods may have drawbacks such as altering the natural composition or characteristics of the spirit, introducing undesirable flavors or contaminants, or requiring complex or costly equipment or materials.

For example, U.S. Pat. No. 3,787,587 discloses a process for accelerated aging of alcoholic beverages by continuously passing actinic light into the beverage in substantially the wave-length range of about 4000 A. to 5500 A. at an irradiation dosage of about 1×10−1 to about 1×10−3 watt-sec./cm3. However, this process may not be suitable for all types of spirits or barrels, as different wave-lengths or dosages may have different effects on different compounds or materials. Moreover, this process may require special light sources or filters that may be expensive or difficult to obtain or maintain.

U.S. Pat. No. 11,053,467 discloses a method for accelerated aging of alcohol spirits under highly pressurized carbon dioxide. The carbon dioxide may form carbonic acid, which may cause various esters to form in the presence of wood as well as to mellow the flavor when no wood is present. Wood may be pretreated with ozone, which may extract lignin which may further convert to vanillin during pressurized CO2 treatment, giving a vanilla note. After processing with pressurized CO2, a post-treatment of ozone may be given to the spirit, which may cause a mild oxidation and further mellowing of the spirit. However, this method may not be suitable for all types of spirits or barrels, as different types of wood may have different reactions with carbon dioxide or ozone. Moreover, this method may require high pressures of carbon dioxide that may pose safety risks or require special equipment or materials.

U.S. Pat. No. 10,633,620 discloses a method for accelerated aging of alcoholic beverages by applying an electric field to a mixture of an alcoholic beverage and wood chips. The electric field may cause electroporation of cell membranes in the wood chips, releasing flavor compounds into the beverage. However, this method may not be suitable for all types of spirits or barrels, as different types of wood chips may have different electrical properties or sizes that may affect the electroporation efficiency or uniformity. Moreover, this method may require special electrodes or power sources that may be expensive or difficult to operate or maintain.

US Pub. No. 2021/0102148 discloses a method for accelerated aging of alcoholic beverages by applying ultrasound waves to a mixture of an alcoholic beverage and wood chips. The ultrasound waves may cause cavitation in the liquid medium, creating microbubbles that implode and generate shock waves that disrupt cell walls in the wood chips, releasing flavor compounds into the beverage. However, this method may not be suitable for all types of spirits or barrels, as different types of wood chips may have different acoustic properties or sizes that may affect the cavitation efficiency or uniformity. Moreover, this method may require special transducers or generators that may be expensive or difficult to operate or maintain.

Therefore, there is a need for an improved method and system for accelerated aging of alcoholic spirits using controlled pressure differences inside and outside the barrels, which can overcome the drawbacks of the prior art methods.

### SUMMARY OF THE INVENTION

The invention provides a method and system for accelerated aging of alcoholic spirits using controlled pressure differences inside and outside the barrels. The method comprises: filling a barrel with an alcoholic spirit; sealing the barrel with a valve; connecting the valve to a pressure controller; setting a desired pressure difference between the inside and outside of the barrel; applying the pressure difference for a predetermined time; reversing the pressure difference for another predetermined time; and repeating the cycle until a desired flavor profile is achieved. The system comprises: a barrel filled with an alcoholic spirit; a valve sealing the barrel; a pressure controller connected to the valve; and a timer controlling the duration of each cycle. The invention allows for precise control and adjustment of the pressure differences and cycle times, which can be varied according to the type of spirit, barrel, wood, and desired outcome. The invention also allows for simultaneous aging of multiple barrels with different settings. The invention can accelerate the aging process by enhancing the extraction of compounds from the wood, increasing the evaporation of water and alcohol, and promoting the chemical reactions between the spirit and the wood. The invention can also improve the consistency and quality of the aged spirits by reducing the variability of environmental factors.

This summary is provided merely to summarize some example embodiments to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

### BRIEF DESCRIPTION OF THE DRAWINGS

Embodiments will be discussed hereafter using reference to the included drawings, briefly described below, wherein like designations refer to like elements:

FIG. 1 is a diagram illustration of the system and method for accelerated aging of alcoholic spirits using controlled pressure differences.

### DETAILED DESCRIPTION OF THE INVENTION

The following detailed description is intended to describe aspects of the invention in sufficient detail to enable those skilled in the art to practice the invention. Other embodiments can be utilized, and changes can be made without departing from the scope of the invention. Therefore, the following detailed description is not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, embodiments of the invention can include a variety of combinations and/or integrations of the embodiments described herein.

The following description is provided as an example of one possible embodiment of the invention and is not intended to limit the scope or applicability of the invention.

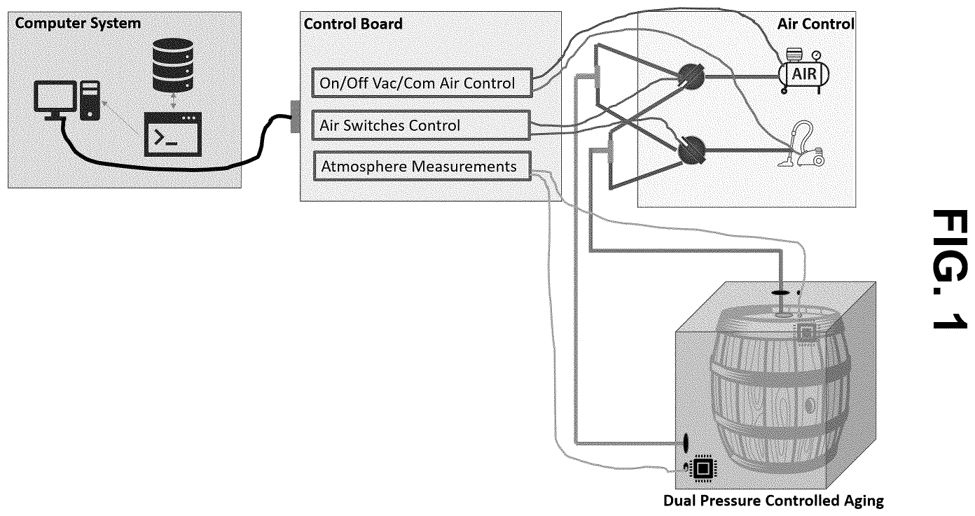

The invention provides a method and system for accelerated aging of alcoholic spirits using controlled pressure differences inside and outside the barrels. As visualized in FIG. 1, the system comprises: A barrel filled with an alcoholic spirit, such as whiskey, rum, brandy, tequila, or any other spirit that can benefit from aging in wooden barrels. The barrel can be made of any suitable wood material, such as oak, cherry, maple, or any other wood that can impart desirable flavor compounds to the spirit. The barrel can have any suitable size and shape, such as a standard 53-gallon barrel or a smaller 5-gallon barrel. A valve sealing the barrel, preventing any leakage or contamination of the spirit. The valve can be any suitable type of valve that can withstand high pressure differences, such as a ball valve or a butterfly valve. A pressure controller connected to the valve, regulating the flow of air or gas in or out of the barrel. The pressure controller can be any suitable device that can measure and adjust the pressure inside and outside the barrel, such as a pump, a compressor, a regulator, or a combination thereof. The pressure controller can also have a display showing the current pressure difference and a knob allowing the user to set a desired pressure difference. A timer controlling the duration of each cycle. The timer can be any suitable device that can measure and set the time intervals for applying and reversing the pressure difference, such as a clock, a stopwatch, a countdown timer, or a combination thereof. The timer can also have a display showing the current cycle time and buttons allowing the user to start, stop, pause, or reset the timer.

The method comprises: Filling a barrel with an alcoholic spirit, such as whiskey, rum, brandy, tequila, or any other spirit that can benefit from aging in wooden barrels. Sealing the barrel with a valve, preventing any leakage or contamination of the spirit. Connecting the valve to a pressure controller, regulating the flow of air or gas in or out of the barrel. Setting a desired pressure difference between the inside and outside of the barrel, using the knob on the pressure controller. The desired pressure difference can be any suitable value that can create a pumping effect that forces the spirit in and out of the wood pores, enhancing the extraction of compounds from the wood, increasing the evaporation of water and alcohol, and promoting the chemical reactions between the spirit and the wood. The desired pressure difference can vary according to the type of spirit, barrel, wood, and desired outcome, but in general, it can range from 0.5 to 5 millibars, or more preferably, from 1 to 3 millibars.

Applying the pressure difference for a predetermined time, using the timer to control the duration of each cycle. The predetermined time can be any suitable value that can allow for sufficient contact between the spirit and the wood, but in general, it can range from 1 to 60 minutes, or more preferably, from 5 to 30 minutes.

Reversing the pressure difference for another predetermined time, using the timer to control the duration of each cycle. Another predetermined time can be the same as or different from the first predetermined time, depending on the desired effect. For example, a longer time at lower pressure can favor the extraction of compounds from the wood, while a shorter time at higher pressure can favor the evaporation of water and alcohol.

Repeating the cycle until a desired flavor profile is achieved. The desired flavor profile can be determined by various methods, such as sensory evaluation, chemical analysis, or consumer preference. The number of cycles required to achieve the desired flavor profile can vary according to the type of spirit, barrel, wood, and desired outcome, but in general, it can range from 10 to 1000 cycles, or more preferably, from 50 to 500 cycles.

Similarly, as shown in FIG. 1, the system further comprises:

A barrel container enclosing the barrel, creating a sealed space around the barrel. The barrel container can be a sturdy box or a large canister where the barrel resides or a large room able to control heat, humidity, and pressure in the space. The barrel container can allow for pressurization or vacuum of the space outside the barrel at the same time the inside of the barrel is having the opposite applied, vacuum or pressure. This can allow for higher levels of force to be applied. It can also allow for testing using only pressure or vacuum outside the barrel and using vacuum or pressure only inside the barrel for more thorough testing of atmosphere effects relative to where the pressures are applied to the barrel. This can push liquids deeper into the wood pores during higher internal atmosphere and pull more wood flavor out of the pores into the liquid in the barrel during lower internal atmosphere.

A computer connected to the pressure controller, the timer, and the atmospheric sensing devices. The computer can control the pressure inside and outside the barrel, and record and store the data in a database. The computer can also reference the database for the requirements of the pressures and cycle times. The database can keep track of barrels, pressures, cycles, and other relevant information.

A first pressure device connected to the valve and the first air switching device. The first pressure device can be a small low pressure air compressor, driving the air pressure up inside and outside the barrel at opposite times in the cycle. Meaning, it can first pressurize inside the barrel in the first part of the cycle and then the outside of the barrel in the second part of the cycle.

A second pressure device connected to the valve and the second air switching device. The second pressure device can be a vacuum, creating mild suction or vacuum inside and outside of the barrel at opposite times in the cycle. Meaning, it can first create a vacuum inside the barrel in the first part of the cycle and then the outside of the barrel in the second part of the cycle.

A first atmospheric sensing device connected to the valve and the computer. The first atmospheric sensing device can measure and report the pressure inside the barrel to the computer, which can record and store the data in the database. The computer can also use the data to adjust and regulate the pressure inside the barrel, using the pressure controller.

A second atmospheric sensing device connected to the barrel container and the computer. The second atmospheric sensing device can measure and report the pressure outside the barrel to the computer, which can record and store the data in the database. The computer can also use the data to adjust and regulate the pressure outside the barrel, using the pressure controller.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular examples of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

Having thus described in various embodiments of the invention, what is claimed as new and desired to be protected by Letters Patent includes the following:

1. A method for accelerated aging of alcoholic spirits using controlled pressure differences inside and outside a sealed barrel, comprising:
filling a sealed barrel with an alcoholic spirit;
sealing a sealed barrel with a valve;
connecting a sealed valve to a pressure controller;
setting a desired pressure difference between a sealed inside and outside of a sealed barrel;
applying a sealed pressure difference for a predetermined time;
reversing a sealed pressure difference for another predetermined time; and
repeating a sealed cycle until a desired flavor profile is achieved.

2. The method of claim 1, wherein a sealed alcoholic spirit is selected from whiskey, rum, brandy, tequila, or any other spirit that can benefit from aging in wooden barrels.

3. The method of claim 1 or 2, wherein a sealed barrel is made of a wood material selected from oak, cherry, maple, or any other wood that can impart desirable flavor compounds to a scaled spirit.

4. The method of any one of claims 1 to 3, wherein a sealed barrel has a size and shape selected from a standard 53-gallon barrel or a smaller 5-gallon barrel.

5. The method of any one of claims 1 to 4, wherein a sealed valve is a ball valve or a butterfly valve.

6. The method of any one of claims 1 to 5, wherein a sealed pressure controller is a pump, a compressor, a regulator, or a combination thereof.

7. The method of any one of claims 1 to 6, wherein a sealed desired pressure difference ranges from 0.5 to 5 milabars.

8. The method of any one of claims 1 to 7, wherein a sealed predetermined time ranges from 1 to 60 minutes.

9. The method of any one of claims 1 to 8, wherein a sealed another predetermined time is the same as or different from a sealed first predetermined time.

10. The method of any one of claims 1 to 9, wherein a sealed number of cycles ranges from 10 to 1000 cycles.

11. A system for accelerated aging of alcoholic spirits using controlled pressure differences inside and outside a sealed barrel, comprising:
a barrel filled with an alcoholic spirit,
a valve sealing a sealed barrel;
a pressure controller connected to a sealed valve; and
a timer controlling a sealed duration of each cycle.

12. The system of claim 11, wherein a sealed alcoholic spirit is selected from whiskey, rum, brandy, tequila, or any other spirit that can benefit from aging in wooden barrels.

13. The system of claim 11 or 12, wherein a sealed barrel is made of a wood material selected from oak, cherry, maple, or any other wood that can impart desirable flavor compounds to a sealed spirit.

14. The system of any one of claims 11 to 13, wherein a sealed barrel has a size and shape selected from a standard 53-gallon barrel or a smaller 5-gallon barrel.

15. The system of any one of claims 11 to 14, wherein a sealed valve is a ball valve or a butterfly valve.

16. The system of any one of claims 11 to 15, wherein a sealed pressure controller is a pump, a compressor, a regulator, or a combination thereof.

17. The system of any one of claims 11 to 16, further comprising:
a barrel container enclosing a sealed barrel, creating a sealed space around a sealed barrel;
a computer connected to a sealed pressure controller, a sealed timer, and atmospheric sensing devices;
a first pressure device connected to a sealed valve and a first air switching device;
a second pressure device connected to a sealed valve and a second air switching device;
a first atmospheric sensing device connected to a sealed valve and a sealed computer; and
a second atmospheric sensing device connected to a sealed barrel container and a sealed computer.

18. The system of claim 17, wherein a sealed barrel container is a sturdy box or a large canister where a sealed barrel resides or a large room able to control heat, humidity, and pressure in the space.

19. The system of claim 17 or 18, wherein a sealed first pressure device is a small low pressure air compressor, driving the air pressure up inside and outside the barrel at opposite times in the cycle.

20. The system of claim 17 or 18, wherein a sealed second pressure device is a vacuum, creating mild suction or vacuum inside and outside the barrel at opposite times in the cycle.

21. The system of any one of claims 17 to 20, wherein a sealed first atmospheric sensing device measures and reports the pressure inside the barrel to the computer, which records and stores the data in the database and adjusts and regulates the pressure inside the barrel, using the pressure controller.

22. The system of any one of claims 17 to 21, wherein a sealed second atmospheric sensing device measures and reports the pressure outside the barrel to the computer, which records and stores the data in the database and adjusts and regulates the pressure outside the barrel, using the pressure controller.
